(19) United States
(12) Patent Application Publication
(10) Pub. No.: US 2011/0304161 A1
(43) Pub. Date: Dec. 15, 2011

(54) TWIST LATCH/LOCK

(76) Inventors: Daniel Behjat, Bella Vista (AU); Alex Morcos, Bella Vista (AU)

(21) Appl. No.: 13/157,610

(22) Filed: Jun. 10, 2011

(30) Foreign Application Priority Data
Jun. 11, 2010 (AU) 2010902582

(51) Int. Cl. E05C 3/14

(52) U.S. Cl. 292/197

(57) ABSTRACT

A rotary latch includes a fascia in the form of a pan, handle connected to a shank defining a longitudinal axis and extending through an aperture in the housing, and a latch arm arranged to rotate about the longitudinal axis as the shank is turned by the handle. A centre bar is mounted behind the housing and oriented perpendicular to the longitudinal axis. The centre bar defines at least one cam follower, A rotatable actuator (rotator) defining a cam surface, and biasing means for biasing the cam follower against the cam surface are also provided. The latch arm is arranged to rotate about the longitudinal axis with the rotator while the distance of the latch arm from the centre bar is fixed and its distance from the housing is controlled by the rotation of the centre bar.

### CROSS-REFERENCE TO RELATED APPLICATIONS

The present application claims priority from Australian provisional patent application No 2010902582 filed on 11 Jun. 2010 entitled Improved Twist Latch/lock, the entire content of which is incorporated herein by reference.

### FIELD OF THE INVENTION

This invention relates to an improved twist action latch or lock.

### BACKGROUND OF THE INVENTION

Twist action locks are commonly used in Australia and overseas for latching and locking doors, cabinets and, in particular, lids of tool boxes. Among existing twist action lock products, is the “drop T” style latch/lock, which uses a T shaped handle to compress the surfaces of a door or lid between a latch tongue and the rear of the lock fascia housing. The latch tongue is mounted to one end of a rotatable shaft which passes through the housing of the lock. On the exterior of this housing, where the rotatable shaft extends beyond the fascia, the “drop T” handle is fitted. The handle is pivoted to the shaft and can be swiveled downwards to become flush with the housing, creating a mechanical pull on the shaft, therefore compressing the lock. To open the lock, the lock barrel must be unlocked, the handle must be lifted to its open or decompressed position, then turned clockwise, or anti clockwise depending on the product specification. This action turns the latch 90 degrees to release the latch that keeps the surfaces of the door or lid fastened, therefore allowing the door or lid to be opened. Whilst this “drop T” type of latch mechanism functions adequately, there are various flaws and problems with the mechanism.

First, the action of the “drop T” style lock is quite primitive. The tactile feel and movement of the lock is at times too loose, and at other times too stiff. This is because of the way in which the components react with the door or lid that is being fastened. The latch lock mechanism has a cumbersome and ‘clunky’ turning motion with loose and rattling parts, rather than presenting a smooth controlled operation.

Secondly, “drop T” style locks require/take a number of steps/operations to unlock, open and turn the lock.

Further, in many applications the way in which the handle must be manually lifted and turned to open the lock and then repeated in reverse to close is inconvenient particularly when the lock is used in industrial applications while the operator is trying to simultaneously manipulate tools and equipment. Further, the “drop T” style lock is difficult to manipulate when wearing gloves and this can cause delays in operation in some applications such as in the mining industry and in accessing fire fighting equipment where workers typically wear bulky protective gloves.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to the present invention, there is provided a rotary latch including a fascia or housing, typically in the form of a pan, a handle arranged to rotate a shaft defining a longitudinal axis and extending through an aperture in the housing, a latch arm arranged to rotate about the longitudinal axis as the shank is turned by the handle, a centre bar which is mounted behind the housing and is movable in the axial direction towards and away from the housing and is oriented generally perpendicular to the longitudinal axis which bar defines at least one cam follower, a rotatable actuator defining a cam surface along which the cam follower is arranged to travel, and biasing means for biasing the cam follower against the cam surface and rotatable actuator, the latch arm being arranged to rotate about the longitudinal axis with the rotatable actuator, while the axial distance of the latch arm from the centre bar is fixed and is controlled by movement of the centre bar towards and away from the housing.

The cam follower may define first and third surfaces which, in use, are oriented in first and third planes generally perpendicular to the longitudinal axis linked by a ramped surface which is oriented at a non-perpendicular angle to the longitudinal axis. The third surface is distal from the housing compared with the first surface. The cam follower surface is typically arcuate, having a centre of curvature on the longitudinal axis.

As the compression spring pushes the cam follower into contact with the cam surface defined by the rotatable actuator, the centre bar increases its distance between itself and the rear of the housing.

An end wall or stop is preferably provided at the end of the third surface positioned such that once the handle and rotatable actuator (rotator) has turned through 90 Degrees, the handle will stop turning.

The centre bar is connected by two posts to a bracket, on which the latch tongue is rotatably mounted. The bracket is preferably threaded to allow the distance between the latch tongue and the rear of the fascia to be adjusted, depending on where the lock will be used and in which application. Typically, two nuts are used to regulate this distance, however there is a bush located in between the two nuts on which the tongue is mounted. The bush serves two purposes, the first being to allow the latch tongue to smoothly swivel or rotate without wearing on the threaded surface of the extrusion. The second purpose is to maintain a set distance between the two distance regulating nuts and prevent them from fastening tightly against either side of the tongue plate.

It is preferred that the centre of the bracket is hollow, allowing the shaft of the handle to rest within it while in its closed and locked position.

Typically to control the rotational movement of the latch tongue, and ensure it rotates with the rotator and handle two posts are located on the rear of the rotator component, which locate in apertures in the latch tongue and guide it in its rotational movement.

Preferably, the range of travel from the latch tongue to the fascia is about 5-6 mm.

In reverse, when the user wants to close the lock, the handle is turned in the reverse direction, which forces the centre bar to be pushed towards the rear of the housing through the bearings contact with the inner rotator surface ramp.

Once the bearings have reached the top of the ramp, they sit in a small groove which holds the centre bar in place. This is made possible by the spring forcing the roundness of the bearing surface into the groove which can be released with a certain amount of turning pressure from the hand. This brings the latch tongue to a tight grip between the surfaces of the doors or lids that are being fastened. The handle is then pushed into the fascia which is caught by a spring loaded catch from the lock barrel, ready to be unlocked with its designated key for repeated use. The layout of these components allows a smooth and controlled dynamic of the opening and closing of the lock. The minimal user hand movement highly increases user satisfaction.

In a related aspect, the invention may provide rotary latch including a housing defining an aperture, a handle mounted on a shaft extending through the housing, the shaft defining a longitudinal axis, a locking tongue mounted for rotation about the axis and constrained to turn as the handle is turned, the locking tongue being located on an opposite side of the housing to the handle, a cam follower mounted on a member and engaged with a cam surface defined on a second member, the cam surface defining at least one ramp, wherein rotation of the handle about the axis is arranged to cause rotation of one of the first or second members with the other member being prevented from rotation about the longitudinal axis relative to the housing and wherein the relative rotation of the first and second members is actuated arranged to cause the locking tongue to move in the direction of the longitudinal axis towards or away from the housing.

Advantageously, the present invention may provide a twist action latch having a highly controlled and smooth turning action that is ideal in applications where ease of use and precision of movement are essential in its operation.

Typical applications for locks embodying the present invention include, but are not limited to locks and latches for opening, closing and locking doors and box lids. The fields in which such locks could be used include the industrial, mining, defense and transportation markets, and more specifically for use with trucks, caravans, utility vehicles, storage purposes, and any other uses within these market areas where there is a need for a lock system that is subject to continual and repetitive hand opening.

### BRIEF DESCRIPTION OF THE DRAWINGS

A specific embodiment of the present invention will now be described, by way of example only, and with reference to the accompanying drawings in which:—

FIG. 1a shows a front isometric view of a latch embodying the invention;

FIG. 1b shows a rear isometric view of the latch of FIG. 1;

FIG. 2 is an exploded view of the latch mechanism of FIG. 1 showing its components;

FIG. 3 is a side view of the latch mechanism shown in FIG. 1, showing the lock in the fully closed position and with a latch handle in its horizontal closed state;

FIG. 4 illustrates a first stage in the opening sequence with the handle lifted to enable turning and turned through a small angle;

FIG. 5 illustrates a second stage in the opening sequence with the handle turned through 25°;

FIG. 6 illustrates a third stage in the opening sequence with the handle turned through 60°; and

FIG. 7 illustrates a fourth and final stage in the opening sequence with the latch turned through its maximum of 90°; and

FIG. 7a is a front isometric view of the latch at that final stage.

### DETAILED DESCRIPTION OF A PREFERRED EMBODIMENT

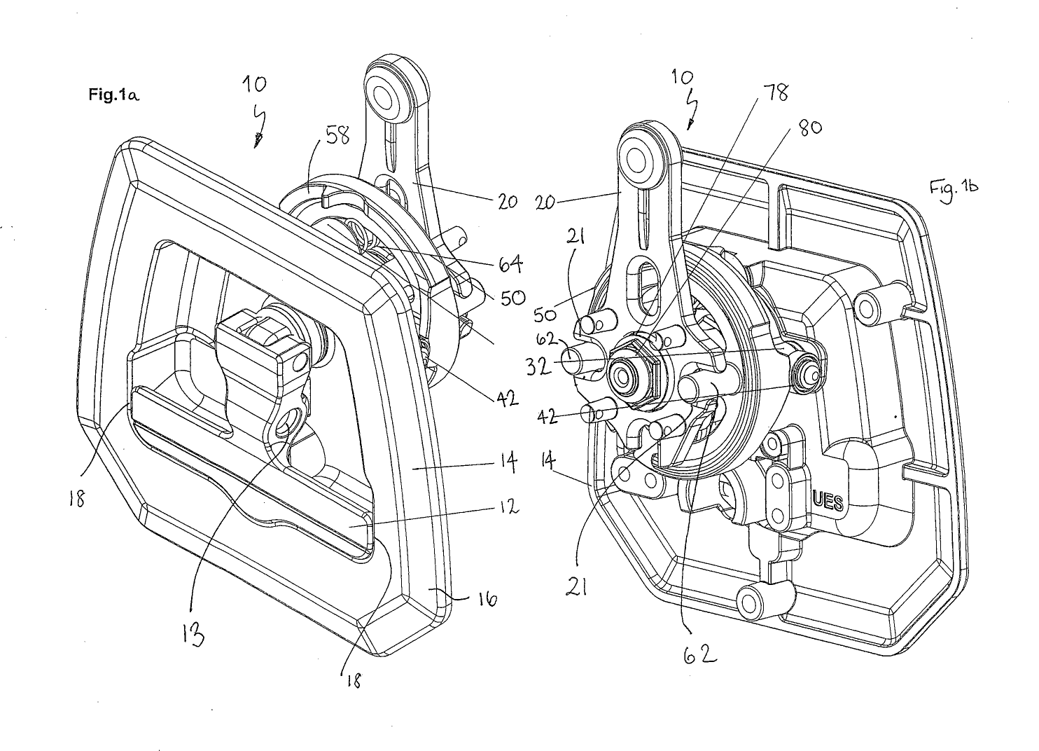

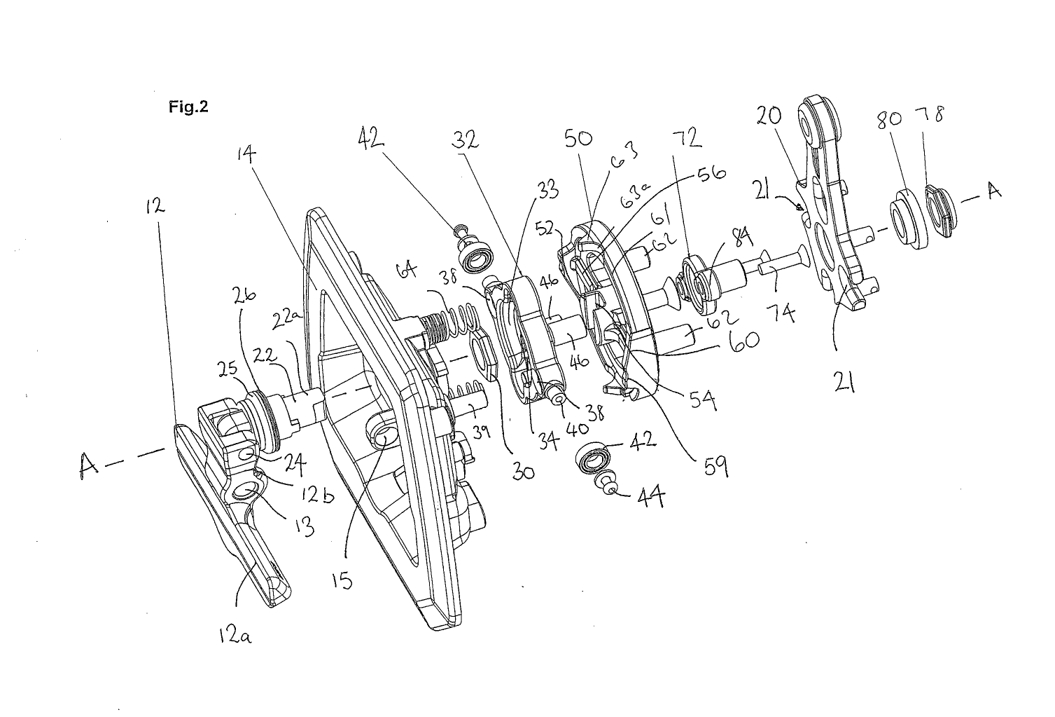

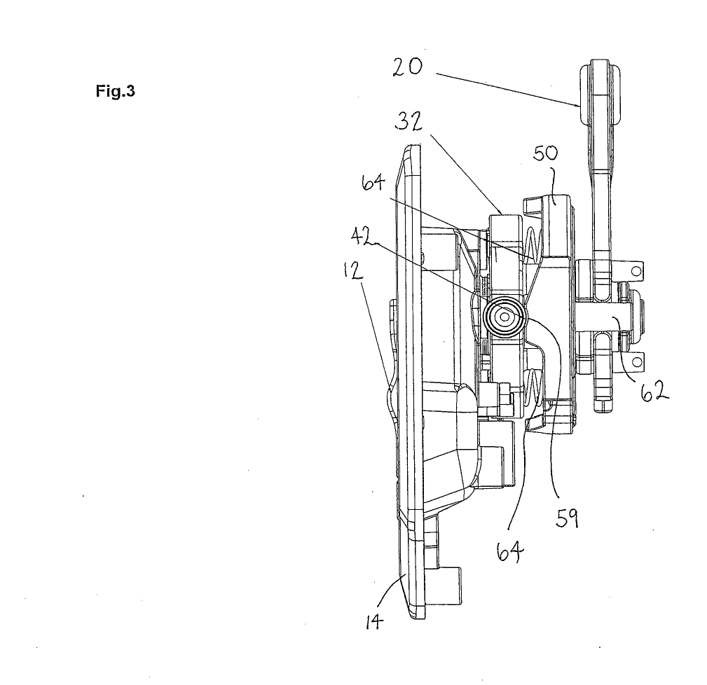

Referring to the drawings, FIGS. 1a, 1b and 2 illustrate a latch mechanism and the components of that mechanism, with FIGS. 3 to 7 illustrating the operation of the lock.

FIG. 1a shows the external appearance of the latch 10 in use showing a latch handle 12 which is recessed into a housing/fascia 14 in the form of a pan which includes an outer flange 16, which defines two opposed recesses 18 for receiving opposed ends of the handle 12. Also visible in FIGS. 1a and 1b is a latch arm in the form of a locking tongue 20.

FIG. 2 is an exploded view showing the separate components of the latch.

With reference to FIG. 2, from the left to right is shown the T-handle 12 which has a crosspiece 12a and a depending shank 12b by which it is pivotally mounted to a shaft 22 about a pin 24. The shaft 22 is generally cylindrical but defines two opposed flats at its end 22a which is generally rectangular. A circular aperture 13 extends through the shank 12b. The shaft 22 defines a longitudinal axis A (refer to FIG. 2) about which the handle may turn. The axis defined by the pin 24 is perpendicular to the axis A. A cup washer 25 and sealing washer 26 locate on the shank.

A ring 15 (best seen in FIG. 2) projects from the pan 14 and defines a circular aperture which is co-axial with the circular aperture 13 when the latch is in a closed position (shown in FIG. 1a) and can be used to lock the latch in that position using a padlock or the like passing through both apertures 13 and 15.

A nut 30 and a centre bar 32 are located on the opposite side of the pan.

The centre bar 32 includes a generally annular central portion 33 defining a circular aperture 34 (through which the longitudinal axis A passes). The centre bar includes two annular cylinders 38 are disposed on opposed sides of the central portion 33 whose central axes are parallel to axis A. The apertures in the cylinders receive two posts 39 (of which only one is visible in FIG. 2) which extend from the rear of the housing 14. The posts prevent the centre bar from rotating relative to the housing 14 while permitting the centre bar to move towards and away from the housing in an axial direction. At each end of the centre bar 32 there is a respective cylindrical portion 40 whose central axes are perpendicular to axis A. A roller bearings 42 is mounted on each cylindrical portion and fixed there with a screw 44. Two internally threaded tubular portions 46 extend from the rear face of the centre bar, for fixing the centre bar to a tongue bracket 72 of the mechanism, as will be explained in more detail below.

The lock mechanism further includes a rotatable actuator in the form of a rotator wheel 50, which defines a central generally cylindrical portion 52 which has a central aperture 54 for receiving the end of the shaft 22a. The aperture 54 is slot shaped to receive the generally rectangular end 22a of the shaft so that turning the shaft 22a turns the rotator wheel. Two opposed radially extending members 56 extend away from the cylindrical portion 52. An circular cam arm 58 (also shown in FIG. 1a) is supported by the distal ends of each member. The cam arm 58 defines two opposed cam surfaces each defining a first generally planar portion including a shallow recess 59, a second or ramp portion 60, leading down to a third and further planer portion 61. A curved stop or end wall 63 is defined at the distal end of the planar portion 61. Adjacent the end wall there is a shallow recess 63a. Two posts 62 (best seen in FIG. 1b) extend away from the rear side of the rotator wheel members 56 which, in use, engage in two cut out portions 21 in the locking tongue 20, as will be described in more detail below.

The components also include a pair of compression springs 64.

The central portion 52 of the rotator wheel 50 locates inside the aperture 34 of the centre bar and the compression springs 64 are compressed between the centre bar and the housing 14.

The components further include a threaded tongue bracket 72 and associated, threaded tongue bracket screws 74, and a tongue fastening nut 78 (M8 Nylock nut), a tongue rotation bush 80, and the locking tongue 20 which is rotatable on the bush 80. The tongue 20 has an enlarged slightly bulbous end 20a.

The bracket also defines two opposed arms 84 which define tubular apertures which receive the tongue bracket screws 74 for fixing the tongue bracket to the centre bar 32 by means of the tubular portions 46 of the centre bar (refer to FIG. 2), and by means of which the tongue bracket is constrained to rotate with the centre bar.

In the above arrangement it is to be noted that the locking tongue 20 is constrained to rotate about the longitudinal axis with the rotator wheel 50 by virtue of the posts 62 located in the cut out portions 21 of the locking tongue 20. However the locking tongue and rotator wheel can move relative to each other in the axial direction along the longitudinal axis A. The orientation of the centre bar is fixed relative to the housing and it does not rotate relative to the housing. However it can and does move in an axial direction towards and away from the housing 14, and is maintained in contact with the rotator wheel by compression springs. The rotator wheel is constrained to move with the handle.

FIGS. 3 to 7a illustrate the opening of the latch mechanism 10. The sequence begins with FIG. 3 showing the handle 12 in a generally horizontal orientation, (in the same position as it is in FIG. 1a). The roller bearings 42 of the centre bar rest in the shallow grooves 59 defined in the rotator wheel 50. The compression springs 64 which are about 85% compressed, act against the fascia 14 to maintain pressure on the centre bar 32 and maintain the roller bearings 42 in the grooves 59. The locking tongue 20 is in a locked position. At this stage the distance between the rear edge of the fascia and the bulbous end 20a of the tongue 20 is 44 mm.

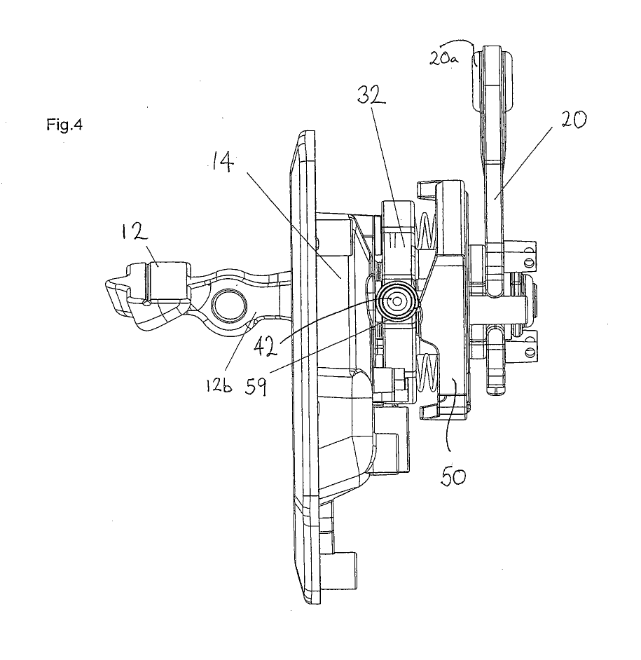

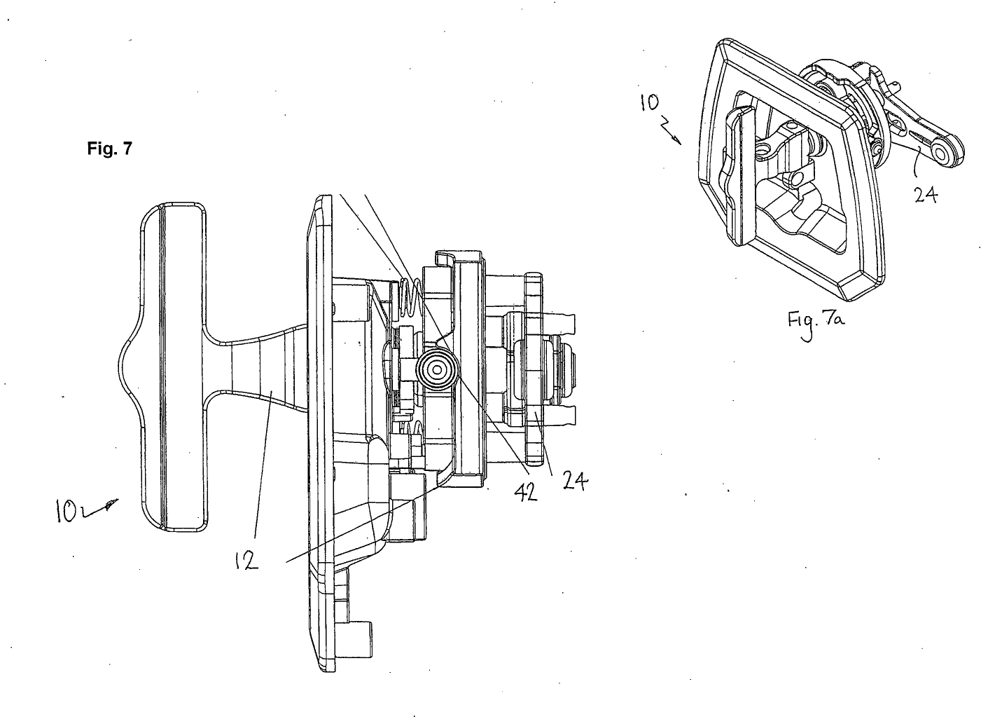

FIG. 4 shows the latch after the handle has been lifted for turning, and rotated through 10°. As the handle 12 is turned in an anti-clockwise direction, the cam arm 58 will control the distance of the centre bar 32 from the fascia 14. Initially, as shown in FIG. 7, the roller bearings 42 ride up out of the shallow grooves 59 over the lip of the groove and the centre bar 32 is compressed 2 mm towards the fascia. The tongue 20 remains perpendicular to the handle 20 at all times.

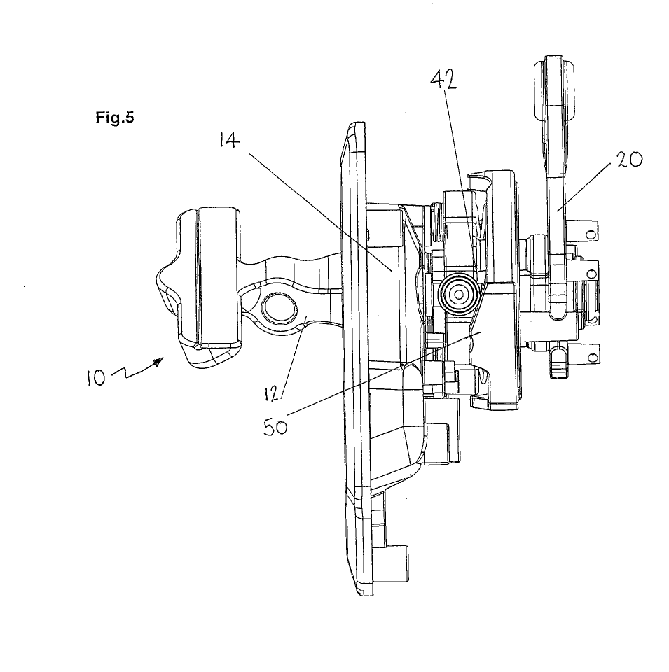

FIG. 5 shows the roller bearings 42 moving along the ramps 60 as the handle is turned through 25°. The compression spring decompresses to maintain the bias and keep the roller bearings in contact with the ramps 60. This makes the turning of the handle and operation of the lock feel very smooth and controlled. The rotator wheel rotates relative to the centre bar but always rotates with the handle and locking tongue 20.

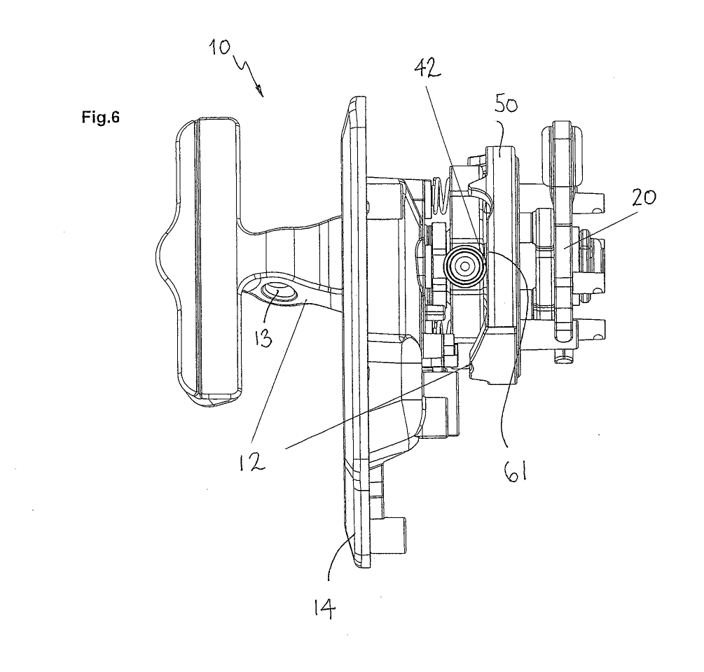

As shown in FIG. 6 the handle has been turned through 60° and the roller bearings 42 have reached the lowest point or further planar portion 61 of the cam rotator wheel, and the latch is 95% decompressed. However, there is still some compression from the compression spring 64, which continues to push the bar 32 against the rotator to provide a smooth and controlled action.

In FIG. 7 the handle has turned through the full 90° and the end walls 63 and grooves 63a which is shown in contact with the roller bearings 42 in FIG. 7 regulate the end of the cam track when the handle is resting at 90°. These components prevent the handle and tongue opening further than 90°.

Again once the roller bearings 42 reach the lowest point of the cam rotator wheel there is still compression from the compression spring 64, which is 85% decompressed and continues to provide a smooth and controlled action.

The end wall which is shown in contact with the roller bearings 42 in FIG. 12 regulates the end of the cam track when the handle is resting at 90 degrees.

At this stage the distance between the rear edge of the fascia and the end 20a of the tongue 20 is 50 mm

The further resting groove 63a in the arcuate rotator track at this end point helps to keep the handle at a fixed 90 degree angle, until the user would apply a certain amount of pressure to the handle in a clockwise direction (depending on the orientation of the components) to reactivate the bearings interaction with the rotator cam wheel ramp.

To close the latch the reverse of the sequences shown in FIGS. 3 to 7 are followed.

Overall, the specific design of these components allows the user to decompress two surfaces and de-latch them a smooth and controlled turning movement.

The latch mechanism can be applied to a broad range of lock products. This type of locking mechanism is ideal for industrial and transportation applications where strong environmental and usage conditions are present.

The latch may optionally include a key operated lock barrel for locking the latch with a key.

Advantageously, the assembled lock mechanism is compact, which improves its versatility and allows it to be fitted to a wide range of products. The mechanism may also be retrofitted to the standard cut-out used on door panels and lids of tool boxes that a drop T latch/lock has been fitted to.

It will be appreciated that although the described lock unlatches when the handle is turned in an anti-clockwise direction, the latch could be set up to unlatch when turned in the opposite (clockwise) sense operating on the same principals.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A rotary latch including a housing, a handle arranged to rotate a shaft defining a longitudinal axis and extending through an aperture in the housing, a latch arm arranged to rotate about the longitudinal axis as the shank is turned by the handle, a centre bar which is mounted behind the housing and is movable in the axial direction towards and away from the housing and is oriented generally perpendicular to the longitudinal axis which bar defines at least one cam follower, a rotatable actuator defining a cam surface along which the cam follower is arranged to travel, and biasing means for biasing the cam follower against the cam surface and rotatable actuator, the latch arm being arranged to rotate about the longitudinal axis with the rotatable actuator, while the axial distance of the latch arm from the centre bar is fixed and is controlled by movement of the centre bar towards and away from the housing.

2. The rotary latch as claimed in claim 1 wherein the cam surface includes a first and third surfaces which, in use, are oriented in first and third planes generally perpendicular to the longitudinal axis and are joined by a second, ramped, surface.

3. The rotary latch as claimed in claim 2 wherein the third surface is distal from the housing compared with the first surface.

4. The rotary latch as claimed in claim 3 wherein the cam surfaces define an arcuate path having a centre of curvature on the longitudinal axis.

5. The rotary latch as claimed in claim 1 wherein the biasing means includes a compression spring arranged to bias the cam follower into contact with the cam surface defined by the rotatable actuator, and wherein a distance between the centre bar and the housing increases as the latch is opened.

6. The rotary latch as claimed in claim 2 wherein the cam surface subtends an angle of about 90° and a stop is provided at an end of the third surface positioned such that once the handle and rotator has turned through 90°, the handle will stop turning.

7. The rotary latch as claimed in claim 6 wherein a shallow recess is defined adjacent the stop.

8. The rotary latch as claimed in claim 1 wherein two posts are extend from a rear face of the rotatable actuator which locate in apertures in the latch arm.

9. A rotary latch including a housing defining an aperture, a handle mounted on a shaft extending through the housing, the shaft defining a longitudinal axis, a locking tongue mounted for rotation about the axis and constrained to turn as the handle is turned, the locking tongue being located on an opposite side of the housing to the handle, a cam follower mounted on a member and engaged with a cam surface defined on a second member, the cam surface defining at least one ramp, wherein rotation of the handle about the axis is arranged to cause rotation of one of the first or second members with the other member being prevented from rotation about the longitudinal axis relative to the housing and wherein the relative rotation of the first and second members is actuated arranged to cause the locking tongue to move in the direction of the longitudinal axis towards or away from the housing.

10. The rotary latch as claimed in claim 9 wherein rotation of the handle about the axis is arranged to cause rotation of one the second member with the first member being prevented from rotation about the longitudinal axis relative to the housing.
